(19) United States
(12) Patent Application Publication
(10) Pub. No.: US 2006/0176525 A1
(43) Pub. Date: Aug. 10, 2006

(54) Analog front-end circuit and electronic apparatus

(75) Inventors: Masahiko Mizuta, Sapporo (JP); Kenji Kimura, Sapporo (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/347,686

(22) Filed: Feb. 3, 2006

(30) Foreign Application Priority Data
Feb. 4, 2005 (JP) 2005-029231

(51) Int. Cl. H04N 1/04

(52) U.S. Cl. 358/474

(57) ABSTRACT

An analog front-end circuit that controls an imaging device and processes an analog image signal output from the imaging device comprises: an analog processor that receives an analog image signal from the imaging device, provides the image signal with predetermined processing, and outputs a resultant signal; an A/D converter that performs A/D conversion with the image signal output from the analog processor; a holding circuit that holds digital image data output from the A/D converter; a timing generator that, based on a first reference clock, generates a plurality of clocks and outputs the clocks to at least one of the analog processor and the A/D converter; and a spread spectrum modulation circuit that performs spread spectrum modulation with the first reference clock and outputs a resultant clock that has been subject to the spread spectrum modulation as a modulated clock to the holding circuit; wherein the holding circuit holds the digital image data from the A/D converter based on the modulated clock output from the spread spectrum modulation circuit.

### BACKGROUND OF THE INVENTION

1. Technical Field

The present invention relates to an analog front-end circuit and an electronic apparatus.

2. Related Art

An image sensor used in an image scanner or the like acquires image signals of image data at its light receiving part and incorporates the signals in its transferring part. The transferring part then receives a driving clock from an image sensor controller that controls the image sensor. Using this clock, the transferring part sequentially shifts and transfers the image data to the outside.

A kind of image scanner has been known to read images using a head-side substrate (carriage) on which a line-shaped image sensor is mounted. When reading images, the head-side substrate is driven by a servomotor or the like, so that its reading position will change step by step. Since the head-side substrate is thus movable, it is coupled with a main substrate having, for example, a circuit for generating a controlling signal for the servomotor via a long cable. Examples of what is supplied via this cable include the image data read by the image sensor and the driving clock required for shift transfer conducted by the image sensor.

As technologies for reading images advance in recent years, image sensors have been developed for higher resolution. When using such a high-resolution image sensor for reading images, the frequency of its driving clock needs to be enhanced. Furthermore, higher resolution increases the amount of image data transferred via a cable. Therefore, the image sensor having the head-side substrate coupled with the main substrate via a long cable involves problems including radiation noise occurred in the cable sending image data or driving clocks, for example, and therefore requires measures against electromagnetic interference (EMI). JP-A-2004-172854 is an example of related art.

### SUMMARY

An advantage of the present invention is to provide an analog front-end circuit that reduces degradation of image data transferred from an image sensor and has a measure against EMI, and also to provide an electronic apparatus including the circuit

An analog front-end circuit according to one aspect of the invention controls an imaging device and processes an analog image signal output from the imaging device. The analog front-end circuit includes: an analog processor that receives an analog image signal from the imaging device, provides the image signal with predetermined processing, and outputs a resultant signal; an A/D converter that performs A/D conversion with the image signal output from the analog processor; a holding circuit that holds digital image data output from the A/D converter; a timing generator that, based on a first reference clock, generates a plurality of clocks and outputs the clocks to at least one of the analog processor and the A/D converter; and a spread spectrum modulation circuit that performs spread spectrum modulation with the first reference clock and outputs a resultant clock that has been subject to the spread spectrum modulation as a modulated clock to the holding circuit; wherein the holding circuit holds the digital image data from the A/D converter based on the modulated clock output from the spread spectrum modulation circuit.

With this structure, the holding circuit holds the image data based on the modulated clock, thereby outputting the image data as a signal that has been subject to the spread spectrum modulation. Accordingly, even if the image data are output from the holding circuit to a main substrate, for example, via a long cable or the like, radiation noise occurring at the cable can be sufficiently reduced.

Furthermore, since the image data output from the holding circuit are digital data, the image data can be correctly output to the main substrate, for example, even if the output of the holding circuit has been subject to the spread spectrum modulation. Consequently, high-definition image data can be output to the main substrate, for example, even if the output of the analog front-end circuit has been subject to the spread spectrum modulation.

In the present aspect, the timing generator may generate, based on the first reference clock that has not been subject to spread spectrum modulation, a plurality of driving clocks that have not been subject to spread spectrum modulation for driving the imaging device and output the clocks to the imaging device, and the signal of the image data output from the holding circuit may be a signal that has been subject to spread spectrum modulation.

With this structure, the timing generator can generate the driving clocks based on the first reference clock that has not been subject to spread spectrum modulation, thereby supplying appropriate driving clocks to a transferring part of an image sensor. This structure can control appropriate shift transfer to a high-resolution image sensor. Accordingly, the analog front-end circuit can receive analog image data with little noise from the image sensor.

In other words, spread spectrum modulation is performed for the signals output from the analog front-end circuit to the main substrate, for example, and not performed for the driving clocks supplied to the image sensor. Consequently, it is possible to transfer high-definition image data and also provide a measure against EMI.

The analog front-end circuit of the present aspect may further include a PLL circuit that generates the first reference clock, and the PLL circuit may receive a second reference clock, multiply a frequency of the second reference clock with N (N is a natural number more than 1), and output a resultant clock as the first reference clock.

With this structure, the first reference clock is generated by multiplying the second reference clock. By setting a desirable multiplying factor, it is possible to adjust driving and other clocks required for controlling the image sensor and a clock required for A/D conversion, for example. Accordingly, the analog front-end circuit of this structure can flexibly cope with user needs and enhance versatility.

In the present aspect, the timing generator may generate, based on the first reference clock that has not been subject to spread spectrum modulation, an A/D conversion clock that has a lower frequency than the first reference clock, and output the clock to the A/D converter.

With this structure, the timing generator generates the A/D conversion clock that has a lower frequency than the first reference clock. Since the modulated clock based on the first reference clock has a higher frequency than the A/D conversion clock, the holding circuit can hold the image data output from the A/D converter without fail.

In the present aspect, the analog processor may provide correlated double sampling and amplification as the predetermined processing.

Accordingly, the analog processor adjusts the analog image signal output from the image sensor to eliminate noise etc. and to have an appropriate signal level for the A/D converter of a downstream stage, for example, thereby correctly processing the image data.

In the present aspect, the timing generator may include a clock pattern setting register that sets patterns of the plurality of clocks, and the timing generator may generate the plurality of clocks with different clock patterns from the first reference clock based on set values in the clock pattern setting register.

With this structure, driving cocks required for the image sensor can be generated within the analog front-end circuit. In other words, since the driving clocks are generated based on the first reference clock, it is possible to perform spread spectrum modulation for the output of the holding circuit without performing spread spectrum modulation for the driving clocks.

Moreover, even if the head-side substrate on which the image sensor and the analog front-end circuit are mounted and a main substrate, for example, are coupled via a long cable, the high-frequency driving clocks can be supplied to the image sensor without using the cable. Therefore, radiation noise occurring at the cable can be sufficiently reduced.

An electronic apparatus according to another aspect of the invention includes a head-side substrate on which any analog front-end circuit that has been described above and an imaging device are mounted, a main substrate on which an image processor that processes image data output form the analog front-end circuit is mounted, and a coupling cable that couples the head-side substrate and the main substrate, wherein a signal of image data that have been subject to spread spectrum modulation is transferred via the coupling cable.

In the present aspect, the plurality of driving clocks for driving the imaging device may be supplied from the analog front-end circuit to the imaging device without using the coupling cable.

An electronic apparatus according to yet another aspect of the invention includes: a head-side substrate on which an analog front-end circuit that controls an imaging device and processes an analog image signal output from the imaging device is mounted; a main substrate on which an image processor that processes image data output form the analog front-end circuit is mounted; and a coupling cable that couples the head-side substrate and the main substrate; the analog front-end circuit having: an analog processor that receives an analog image signal from the imaging device, provides the image signal with predetermined processing, and outputs a resultant signal; an A/D converter that performs A/D conversion with the image signal output from the analog processor; a timing generator that, based on a modulated clock, generates a plurality of clocks and outputs the clocks to at least one of the analog processor and the A/D converter; and a spread spectrum modulation circuit that performs spread spectrum modulation with a first reference clock and outputs a resultant clock that has been subject to the spread spectrum modulation as a modulated clock to the timing generator; wherein a signal of image data that have been subject to spread spectrum modulation is transferred via the coupling cable.

With this structure, it is possible to perform the spread spectrum modulation for the output signal of the analog front-end circuit, and thereby radiation noise occurring at the coupling cable can be sufficiently reduced.

The analog front-end circuit of the present aspect may further include a PLL circuit that generates the first reference clock, and the PLL circuit may receive a second reference clock, multiply a frequency of the second reference clock with N (N is a natural number more than 1), and output a resultant clock as the first reference clock.

In the present aspect, the timing generator may generate an A/D conversion clock that has a lower frequency than the modulated clock based on the modulated clock, and output the clock to the A/D converter.

In the present aspect, the timing generator may include a clock pattern setting register that sets patterns of the plurality of clocks, and the timing generator may generate the plurality of clocks with different clock patterns from the modulated clock based on set values in the clock pattern setting register.

With this structure, since the timing generator generates the driving clocks, it is possible to provide the image sensor with the high-frequency driving clocks without using the coupling cable. Accordingly, radiation noise occurring at the coupling cable can be sufficiently reduced.

### BRIEF DESCRIPTION OF THE DRAWINGS

The invention will be described with reference to the accompanying drawings, wherein like numbers reference like elements.

FIGS. 1A to 1C are diagrams describing an image sensor.

FIG. 2 shows a configuration example of an analog front-end circuit according to an embodiment of the invention.

FIG. 3 is a diagram describing frequency spectrum peak values.

FIG. 4 is a diagram describing the spread of frequency spectrum peak values.

FIG. 5 shows a configuration example of a spread spectrum modulation circuit according to the present embodiment.

FIG. 6 is a waveform chart showing the degree of spread spectrum modulation.

FIG. 7 is a table showing a setting example of a clock pattern setting register according to the present embodiment.

FIG. 8 is a waveform chart showing a plurality of clocks based on the setting example shown in FIG. 7.

FIG. 9 shows a configuration example of an analog processor according to the present embodiment.

FIG. 10 is a chart showing an A/D conversion clock and a modulated clock according to the present embodiment.

FIG. 11 shows a configuration example of an electronic apparatus according to the present embodiment.

FIG. 12 shows coupling between a head-side substrate and a main substrate included in the electronic apparatus according to the present embodiment.

FIG. 13 shows a modification of the analog front-end circuit according to the present embodiment.

FIG. 14 shows an electronic apparatus of a comparative example according to the present embodiment

### DESCRIPTION OF THE PREFERRED EMBODIMENT

An embodiment of the invention will be described with reference to the accompanying drawings. The embodiment described below is not intended to unreasonably limit the invention set forth in the claims. Also, it should be understood that not all of the elements described below are required to put the invention into practice.

1. Image Sensor

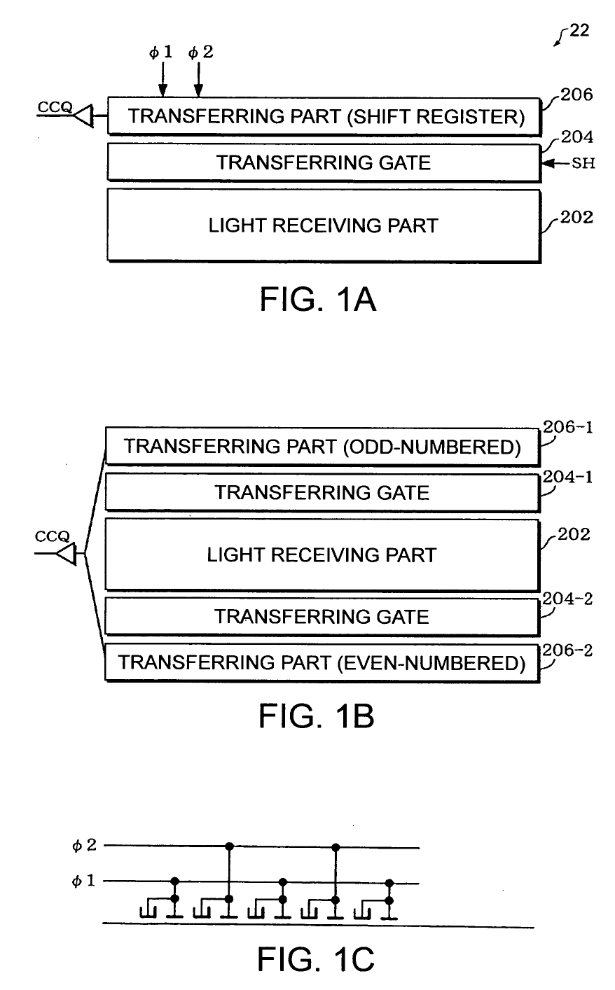

FIG. 1A shows a configuration example of an image sensor 22 (imaging device in a broad sense). This image sensor 22 (e.g. CCD line sensor) includes a light receiving part 202, a transferring gate 204 and a transferring part (shift register) 206, for example. The light receiving part 202 includes a plurality of light receiving elements (photodiodes, pixels) for photoelectric conversion. Note that like numerals indicate like elements throughout the drawings.

Each light receiving element (pixel) included in the light receiving part 202 generates and accumulates charges depending on the amount of light it receives. After a given period of time required for charge accumulation lapses, a shift signal SH becomes active, while the transferring gate 204 turns on. Accumulated charges, which are analog image data, are thus transferred to the shift register (provided correspondingly to each light receiving element) included in the transferring part 206 via the transferring gate 204. The image data (accumulated charges, or image signals in a broad sense) sent to each shift register are then transferred to adjacent shift registers based on two-phase driving clocks Φ1 and Φ2, and serially output from a CCQ terminal of the image sensor 22.

The configuration of the image sensor 22 is not limited to what is described in FIG. 1A. As shown in FIG. 1B, for example, the configuration preferably includes a transferring gate 204-1 for odd-numbered pixels and a transferring part 206-1, and a transferring gate 204-2 for even-numbered pixels and another transferring part 206-2. Moreover, the configuration of FIG. 1A or B preferably includes a light receiving part, transferring gate and transferring part for reading red (R), green (G) and blue (B) image data.

FIG. 1C shows a configuration example of the shift register included in the transferring part 206.

2. Analog Front-End Circuit

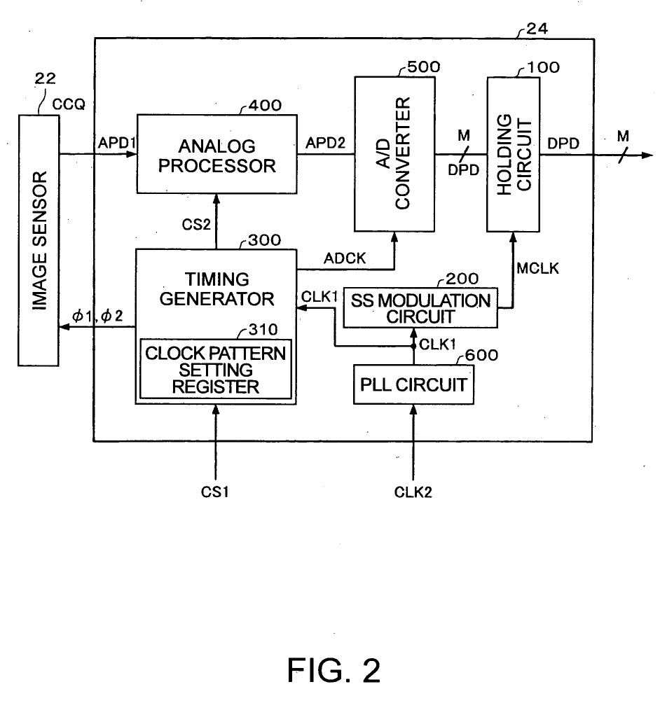

FIG. 2 shows a configuration example of an analog front-end circuit 24 according to the present embodiment. This analog front-end circuit 24 includes, but is not limited to, a holding circuit 100, an SS modulation circuit 200 (spread spectrum modulation circuit in a broad sense), a timing generator 300, an analog processor 400, an A/D converter 500 and a PLL circuit 600. For example, the circuit may not include the analog processor 400 and the PLL circuit 600.

The timing generator 300 receives a reference clock CLK1 from the PLL circuit 600, generates a plurality of clocks based on a control signal CS1 and provides the image sensor 22, the analog processor 400 and the A/D converter 500 with corresponding clocks. Specifically, the timing generator 300 supplies, out of the plurality of clocks it generates, the driving clocks Φ1 and Φ2 to the image sensor 22, an A/D conversion clock ADCK to the A/D converter 500 and a control signal CS2 to the analog processor 400.

The SS modulation circuit 200 performs spread spectrum modulation with the reference clock CLK1 and outputs a modulated clock MCLK to the holding circuit 100.

The analog processor 400 receives analog image data APD1 serially output from the CCQ terminal of the image sensor 22, performs predetermined analog processing based on the control signal CS2 from the timing generator, for example, and outputs the processed data to the A/D converter 500.

The A/D converter 500 based on the A/D conversion clock ADCK from the timing generator 300 performs A/D conversion with analog image data APD2 from the analog processor 400 and outputs digital image data DPD to the holding circuit 100 of a downstream stage. Here, the digital image data DPD are output as M-bit parallel data (M is a natural number). The present embodiment provides a parallel output of 16-bit image data DPD, for example.

The holding circuit 100 latches the M-bit image data DPD based on the modulated clock MCLK. The latched image data DPD are output from the analog front-end circuit 24 as M-bit parallel data, for example, to the main substrate or the like.

The PLL circuit 600 multiplies a reference clock CLK2 (second reference clock in a broad sense) with a predetermined factor to generate the reference clock CLK1 (first reference clock in a broad sense) and outputs the clock to the SS modulation circuit 200 and the timing generator 300. The multiplying factor of the PLL circuit 600 can be adequately set with a register or the like. For example, when the reference clock CLK2 is 10 MHz and the multiplying factor of the PLL circuit 600 is set at 12, the frequency of the reference clock CLK1 is set at 120 MHz. The PLL circuit 600 is not limited to the above description, and may have a fixed multiplying factor.

Also, the analog front-end circuit 24 may be provided with a clock generating circuit to generate the reference clock CLK2.

2.1. SS Modulation Circuit

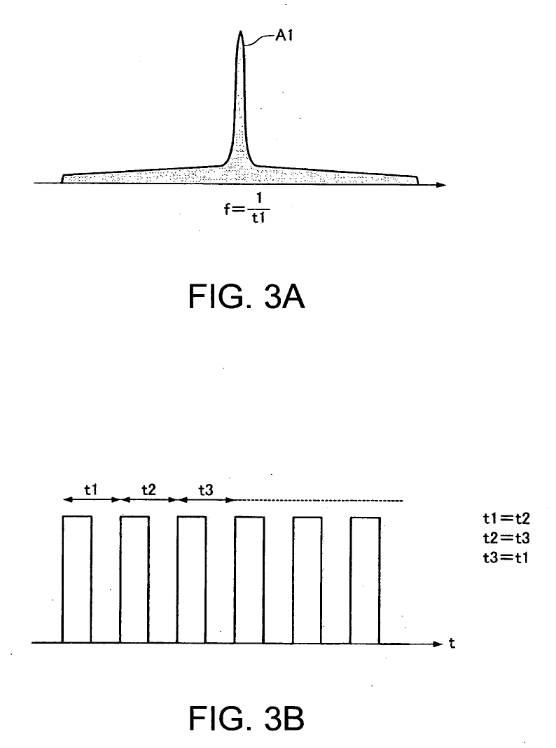

A clock signal with a fixed interval has an obvious peak in its high frequency spectrum. FIG. 3A shows the frequency spectrum of the waveform shown in FIG. 3B. When the cycles t1 to t3 of each pulse are equal as shown in FIG. 3B, for example, the formula F=1/t1 gives an obvious peak as shown by A1 in FIG. 3A. Since this peak causes radiation noise, it must be lowered, for example, to provide a measure against EMI.

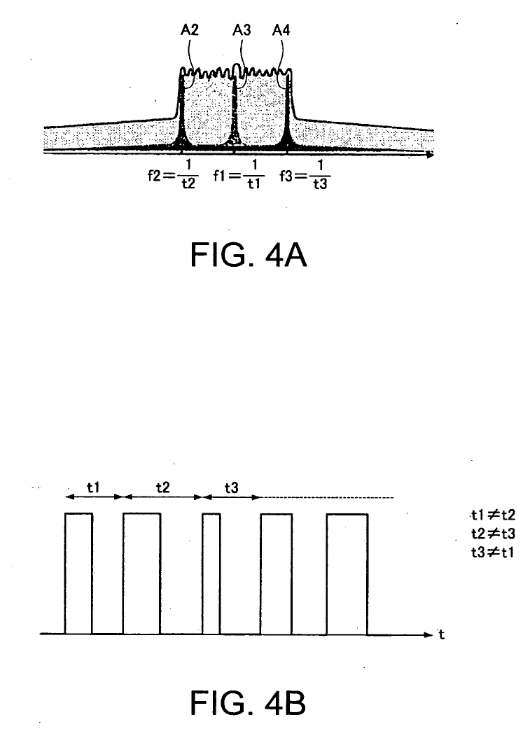

Using a spread spectrum clock generator (SSCG) can spread the frequency spectrum to lower peak values. Modulating the frequency for input clocks to make the cycles t1 to t3 of each pulse differ as shown in FIG. 4B can spread peak values as shown by A2, A3 and A4 in FIG. 4A. The clocks after this spread spectrum modulation have lower peak values shown by A2, A3 and A4 in FIG. 4A than the peak value shown by A1 in FIG. 3A. This means that the SSCG effectively works as a measure against EMI, and the SS modulation circuit 200 provides the spread spectrum modulation as described above.

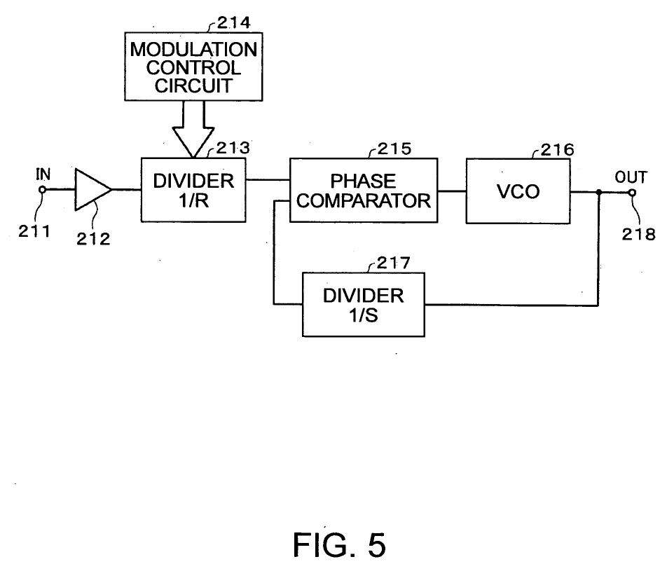

FIG. 5 shows a configuration example of the SS modulation circuit 200. Its input terminal 211 receives the reference clock CLK1, for example. The reference clock CLK1 is then input to a divider 213 via a buffer 212. The divider 213 divides the input clock with R and inputs this 1/R clock to a phase comparator 215. The divisor R of the divider 213 is variable and is set under the control of a modulation control circuit 214.

The phase comparator 215 compares phases of the clocks output from the divider 213 and a divider 217 and outputs a voltage based on the result to a voltage controlled oscillator (VCO) 216. The VCO 216 outputs a clock based on this input voltage to an output terminal 218 and the divider 217. Here, the divider 217 divides the clock output from the VCO 216 with S.

In other words, the phase comparator 215 controls the VCO 216 in a way that the frequencies of the output clock from the divider 213 and of the output clock from the divider 217 become equal. Note that the values R and S are positive real numbers.

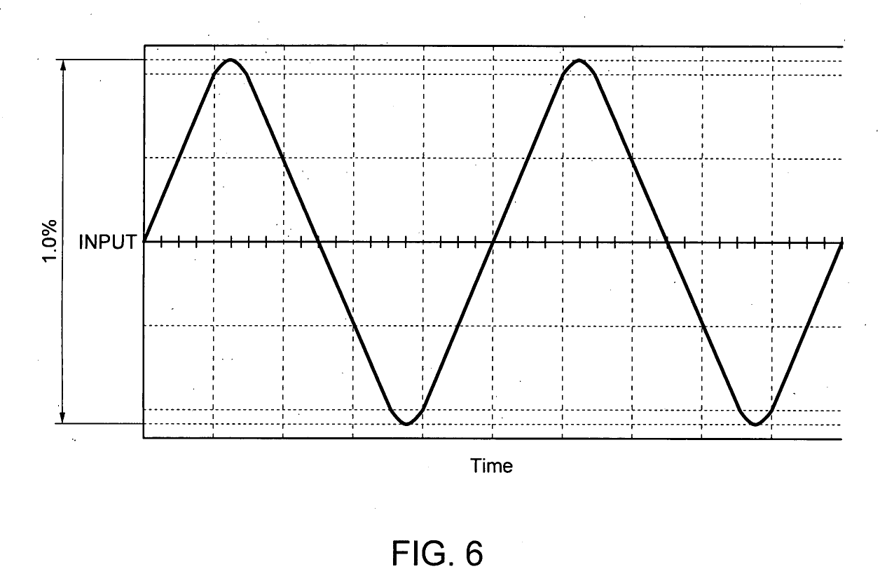

FIG. 6 shows an example of modulation profiles. This chart shows a cycle in which the modulation control circuit 214 varies the divisor R. FIG. 6 shows that input frequencies are modulated by +/−0.5% as an example.

It should be understood that the configuration shown in FIG. 5 is an example of the SS modulation circuit 200 and is not intended to limit other configurations. The SS modulation circuit 200 is a circuit for spread spectrum modulation and may have other configurations. For example, a variable delay circuit may be used for spread spectrum modulation by periodically varying delay time for the rise or fall of the output clock with respect to the rising or falling edge of the input clock.

2.2. Timing Generator

The timing generator 300 shown in FIG. 2 includes a clock pattern setting register 310. The clock pattern setting register 310 stores information on patterns of a plurality of clocks the timing generator 300 generates. Based on the information on clock patterns, the timing generator 300 generates a plurality of clocks. The setting of the clock pattern setting register 310 is variable and programmable by using the control signal CS1, for example. Therefore, a user can store information on desirable clock patters in the clock pattern setting register 310.

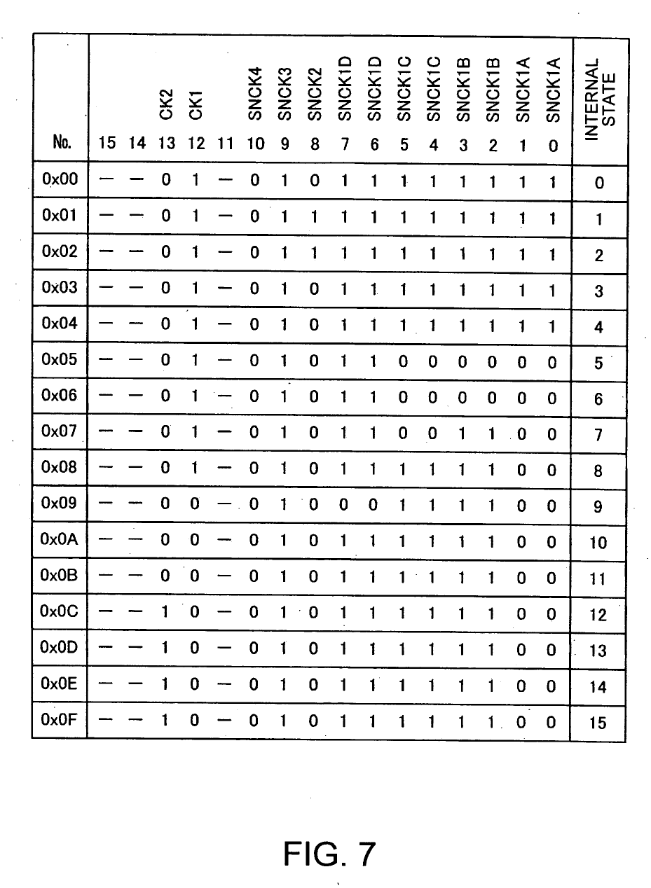

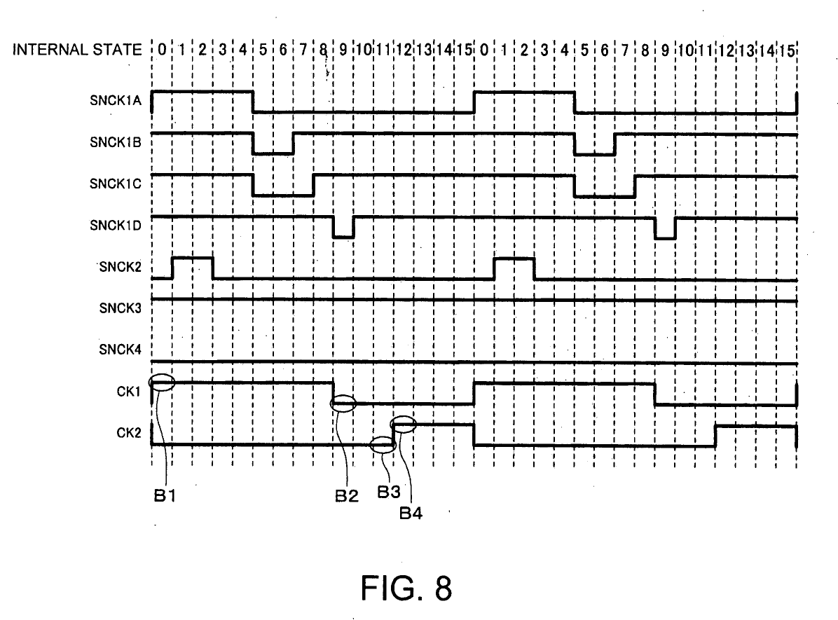

FIG. 7 is a clock pattern table for illustrating information on clock patters stored in the clock pattern setting register 310 in greater detail. The numbers 0x00 to 0x0F shown in FIG. 7 represent addresses of the clock pattern setting register 310. FIG. 8 shows waveforms of the clocks output from the timing generator 300 with the pattern table of FIG. 7.

The symbols CK1 and CK2 in FIG. 7 represent clocks, e.g. a clock for driving the analog processor 400 shown in FIG. 2. The symbols SNCK1A to SNCK1D and SNCK2 to SNCK 4 also represent clocks, and either of them can serve as the driving clock Φ1 or Φ2 for driving the image sensor 22, for example.

During a cycle of the clocks (e.g. the driving clocks Φ1, Φ2) output from the timing generator 300, the internal state increases from 0 to 15. During the next cycle, the internal state again increases from 0 to 15. In this way, the internal state circulates from 0 to 15, for example, based on the reference clock (e.g. the first reference clock CLK1).

Each clock has a clock pattern with 0 or 1, for example, assigned for the individual internal states.

The timing generator 300 sets the output level of each clock based on the value (e.g. 0 or 1) assigned to each clock for the individual internal state as shown in FIG. 7.

Specifically, when the internal state of the clock CK1 is 0, its register shown in FIG. 7 is 1, and therefore the output level of this clock CK1 is high as shown by B1 in FIG. 8. When the internal state increases to 1, its register shown in FIG. 7 is 1, and therefore the output level of this clock CK1 remains high. When the internal state further increases to 9, its register shown in FIG. 7 is 0, and therefore the output level of the clock CK1 becomes low.

In the same manner, when the internal state of the clock CK2 is 11, its register shown in FIG. 7 is 0, and therefore the output level of this clock CK2 is low as shown by B3 in FIG. 8. When the internal state increases to 12, its register shown in FIG. 7 is 1, and therefore the output level of the clock CK2 becomes high as shown by B4 in FIG. 8.

In this way, the timing generator 300 generates each clock based on the values stored in the clock pattern setting register 310 with reference to the reference clock CLK1. Note that since the reference clock CLK1 is not subject to spread spectrum modulation, the driving clocks Φ1 and Φ2 output from the timing generator are not subject to spread spectrum modulation. Therefore, the pulse widths of the driving clocks Φ1 and Φ2 have a fixed cycle, and thereby the timing generator 300 can accurately control image data transferring of the image sensor 22. In other words, the analog front-end circuit 24 receives highly accurate image data from the image sensor 22, and also provides its output of the image data DPD with spread spectrum modulation. Accordingly, the analog front-end circuit 24 of the present embodiment can provide a measure against EMI and also prevent degradation of image quality.

The timing generator 300 generates the A/D conversion clock ADCK based on the reference clock CLK1 and supplies this clock to the A/D converter 500. When the reference clock CLK1 is 120 MHz, for example, the timing generator 300 divides this reference clock CLK1 with 12, for example, and outputs a 10-MHz clock as the A/D conversion clock ADCK.

While FIG. 7 is a pattern table when a single color is assigned to one read pixel, but it does not limit the invention. For example, when the three colors R, G and B are assigned to one read pixel, internal state values may be set in 48 stages from 0 to 47.

2.3. Analog Processor

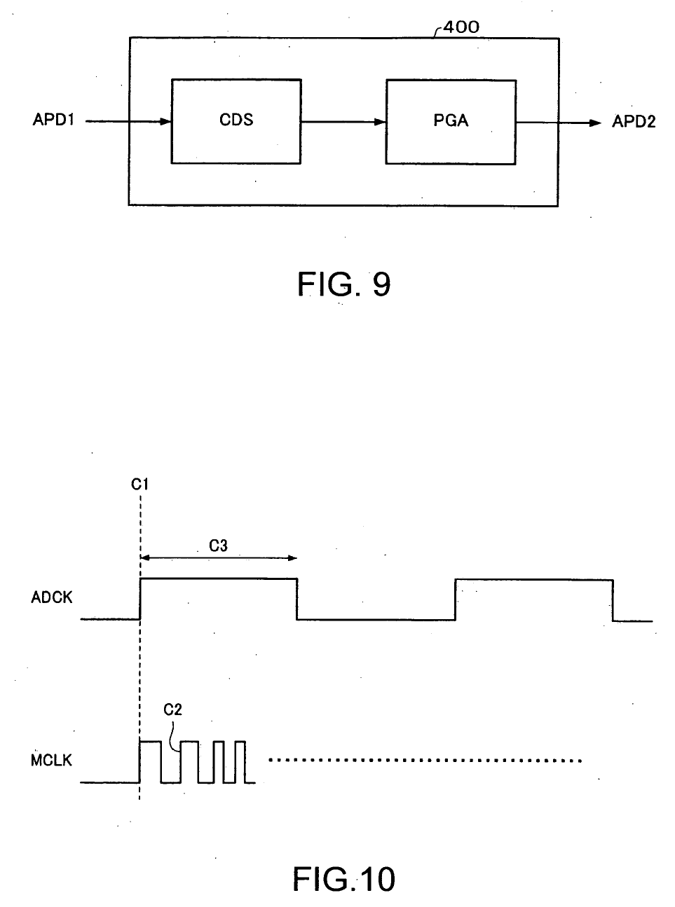

FIG. 9 is a block diagram showing the analog processor 400. The analog processor 400 includes a correlated double sampling processor CDS and an amplification processor PGA.

The correlated double sampling processor CDS receives the analog image data APD1 from the image sensor 22 and samples a base-level (optical black level, reference level) analog signal and a data-level (video level, signal level) analog signal. The processor CDS then outputs a difference between sampling values of the base-level analog signal and the data-level analog signal.

Composed of a programmable gain amplifier or the like, the amplification processor PGA adjusts the output gain of the correlated double sampling processor CDS and outputs the analog image data APD2 to the A/D converter 500. Here, adjusting the gain ensures an adequate dynamic range for the A/D converter 500.

Note that a correction circuit for correcting an output from the correlated double sampling processor CDS may be provided between the correlated double sampling processor CDS and the amplification processor PGA.

When the three colors R, G and B are assigned to a read pixel, the correlated double sampling processor CDS and the amplification processor PGA may be provided for each of the three. In this case, each amplification processor PGA may be coupled with the A/D converter 500 via a multiplexer, for example.

2.4. A/D Converter and Holding Circuit

The A/D converter 500 receives the analog image data APD2 from the analog processor 400 and performs A/D conversion based on the A/D conversion clock ADCK supplied from the timing generator. In the present embodiment, for example, the A/D conversion clock ADCK is set be 10 MHz. Since the analog data APD2 are serially output, for example, the A/D converter 500 performs A/D conversion of the image data APD2 sequentially. The A/D converter 500 then outputs M pieces of data (M is a natural number, e.g. 16) that have been A/D converted as the M-bit (e.g. 16-bit) digital image data DPD based on the clock ADCK to the holding circuit 100.

The holding circuit 100 latches the M-bit image data DPD from the A/D converter 500 based on the modulated clock MCLK from the SS modulation circuit 200. The image data DPD latched by the holding circuit 100 can be used as the output data of the analog front-end circuit 24.

The modulated clock MCLK is obtained by performing spread spectrum modulation with the reference clock CLK1 of 120 MHz, for example. Therefore, the image data DPD latched based on this modulated clock MCLK are output as a digital signal that has been subject to the spread spectrum modulation from the analog front-end circuit 24. Consequently, peak values of the frequency spectrum generated when the analog front-end circuit 24 outputs the image data DPD can be spread. As a result, radiation noise can be reduced, for example.

Note that even if the frequency of the reference clock CLK1, which serves as a reference for generating the modulated clock MCLK, is set at the same (e.g. 10 MHz) as the frequency of the A/D conversion clock ADCK, the analog front-end circuit 24 of the present embodiment can provide the above-described measure against EMI with the function of the SS modulation circuit 200.

According to the present embodiment, setting the frequency of the reference clock CLK1 higher than the frequency of the A/D conversion clock ADCK (in other words, the A/D conversion clock ADCK has a lower frequency than the reference clock CLK1) can be more effective.

Referring to FIG. 10, effects will now be described in greater detail. FIG. 10 shows the A/D conversion clock ADCK and the modulated clock MCLK. For example, if the clock ADCK and the modulated clock MCLK rise at the timing of C1 shown in FIG. 10, the holding circuit 100 starts lathing data almost at the timing of C1 since it latches data based on the modulated clock MCLK. The A/D converter 500, however, determines the data DPD to be output to the holding circuit 100 during the period of C3, and therefore its output might be metastable at the timing of C1. In this case, if the modulated clock MCLK has almost the same frequency as the frequency of the A/D conversion clock ADCK, the holding circuit 100, after it fails to latch data, cannot redo data latching during the period of C3, thereby leaving the data unprocessed.

Here, since the modulated clock MCLK has a sufficiently high frequency than the frequency of the A/D conversion clock ADCK in the present embodiment, the holding circuit 100 can redo data latching during the period of C2 even if it fails to latch data at the timing of C1. That is to say, the holding circuit 100 can latch data for plural times during the period of C3, thereby preventing leaving data unprocessed and ensuring data latching.

3. Electronic Apparatus

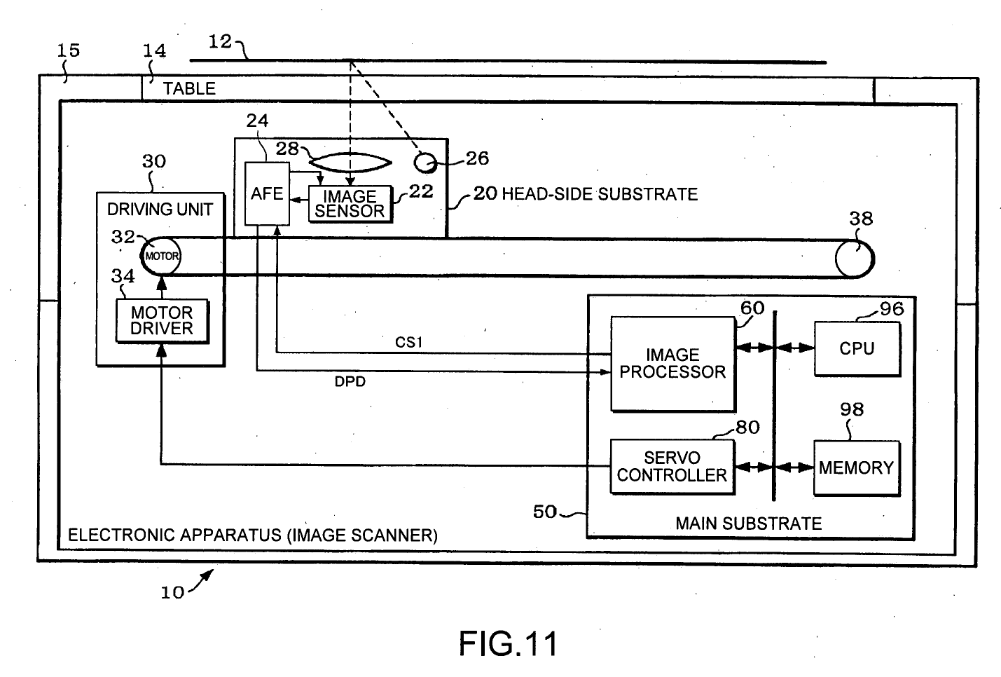

FIG. 11 shows an electronic apparatus 10 including the analog front-end circuit (AFE) 24 according to the present embodiment. It should be noted that not all of the elements shown in FIG. 11 must be included in the electronic apparatus 10, and part of them can be omitted.

The electronic apparatus 10 (e.g. flatbed image scanner) includes a table 14 on which a read object 12 (e.g. manuscript) is placed and a frame 15 (e.g. supporting member or housing) for supporting the table 14. The table 14 is rectangular shaped and made of glass or other light transmissive materials. Upon this light transmissive table 14, for example, the read object 12 is placed.

The electronic apparatus 10 also includes a head-side substrate (carriage) 20 on which the image sensor 22 and the analog front-end circuit 24 are mounted. Examples of the image sensor 22 include a charge coupled device (CCD), a contact image sensor (CIS) and a bucket brigade device (BBD). Also mounted on the head-side substrate 20 is an optical system (optical head) including a light source 26 for illuminating the read object 12 (manuscript) and a lens 28 (light collecting part) for converging light coming from the light source 26 and reflected on the read object 12 on the image sensor 22.

The electronic apparatus 10 also includes a driving unit 30 (driving mechanism) for driving and moving the head-side substrate 20. The driving unit 30 includes a motor 32 (power source) and a motor driver 34 for driving the motor 32. The image sensor 22 is placed such that its longitudinal direction coincides with a main scanning direction. The motor 32 drives one side of a driving belt 36 whose another side is attached to a pulley 38, thereby moving the head-side substrate 20 fixed at the driving belt 36 in an auxiliary scanning direction (perpendicular to the main scanning direction). Here, the head-side substrate 20 can be moved in various ways. For example, the head-side substrate 20 can be moved without using the driving belt 36 or with a linear motor mechanism.

The electronic apparatus 10 also includes a main substrate 50. The main substrate 50 controls each block of the electronic apparatus 10. Specifically, it controls obtaining and processing of image data, provides servo control of the head-side substrate 20 and controls the analog front-end circuit 24.

The main substrate 50 includes an image processor 60. The image processor 60 processes image data obtained from the head-side substrate 20. The image processor 60 may also control the analog front-end circuit 24, for example, but is not limited to this. Other blocks mounted on the main substrate 50 may generate a signal for controlling the analog front-end circuit 24, for example.

The main substrate 50 also includes a servo controller 80. The servo controller 80 provides servo control (feedback control) of the driving unit 30 (motor 32) that drives (moves) the head-side substrate 20. The main substrate 50 also includes a CPU 96 (processor) and a memory 98 (ROM, RAM). The CPU 96 controls the whole of the main substrate 50 and exchanges information with the outside. The memory 98 stores programs and various types of data and also functions as a working area of the image processor 60, the servo controller 80 and the CPU 96.

It should be noted that not all of the elements shown in FIG. 1 must be included in the main substrate 50, and part of them can be omitted. For example, the CPU 96 and the memory 98 can be omitted. Also, the functions of the main substrate 50, the image processor 60 and the servo controller 80 can be provided by a hardware circuit, or by both software and hardware circuits. The hardware circuit may be composed of an application specific integrated circuit (ASIC) including a gate array etc. or of a generic processor.

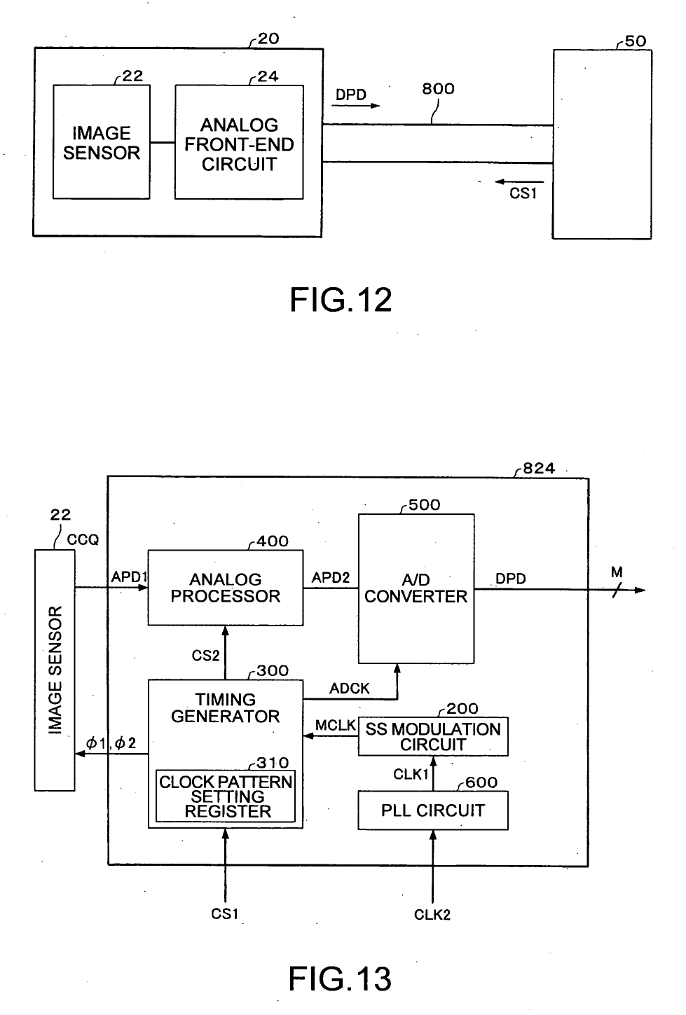

FIG. 12 shows coupling between the head-side substrate 20 and the main substrate 50. The head-side substrate 20 and the main substrate 50 are coupled with a coupling cable 800 composed of a plurality of wires. The image data DPD output from the head-side substrate 20 are supplied to the main substrate 50 via the wires included in the coupling cable 800. In the same manner, the controlling signal CS1 output from the main substrate 50 is supplied to the head-side substrate 20 via the other wires included in the coupling cable 800.

When the analog front-end circuit outputs M-bit image data DPD for example, the coupling cable 800 is provided with M wires to transfer the image data DPD, but the invention is not limited to this.

Since the head-side substrate 20 is driven by the driving unit 30 such that it will move within a predetermined range as shown in FIG. 11, the coupling cable 800 needs to be long enough to fully cover this range. Therefore, the coupling cable 800 of the present embodiment has a certain length (e.g. 60 centimeters).

Generally, the longer the cable is, the bigger EMI attributed to radiation noise occurred in transferring a signal via the cable becomes. As a result, EMI tests and adjustments require time, thereby increasing production costs. To address this issue, the analog front-end circuit 24 of the present embodiment uses the modulated clock MCLK from the SS modulation circuit 200, so that radiation noise occurred at the coupling cable 800 can be effectively reduced. Accordingly, time required for EMI tests and adjustments can be largely reduced, thereby cutting production costs.

FIG. 13 shows an analog front-end circuit 824 as a modification of the present embodiment. This analog front-end circuit 824 does not have the holding circuit 100 in the analog front-end circuit 24, and replaces the reference clock CLK1 with the modulated clock MCLK from the SS modulation circuit 200 to be supplied to the timing generator 300.

The timing generator 300 included in the analog front-end circuit 824 generates a plurality of clocks based on the modulated clock MCLK from the SS modulation circuit 200. Therefore, for example, the A/D conversion clock ADCK from the timing generator 300 has been subject to spread spectrum modulation. In other words, the image data DPD are output from the analog front-end circuit 824 as a clock that has been subject to the spread spectrum modulation. Consequently, the analog front-end circuit 824 can reduce radiation noise in the same manner as the analog front-end circuit 24.

Instead of the analog front-end circuit 24, the analog front-end circuit 824 may be mounted on the electronic apparatus 10. This structure can also effectively reduce radiation noise occurred at the coupling cable shown in FIG. 12.

7. Effects in Comparison with a Comparative Example

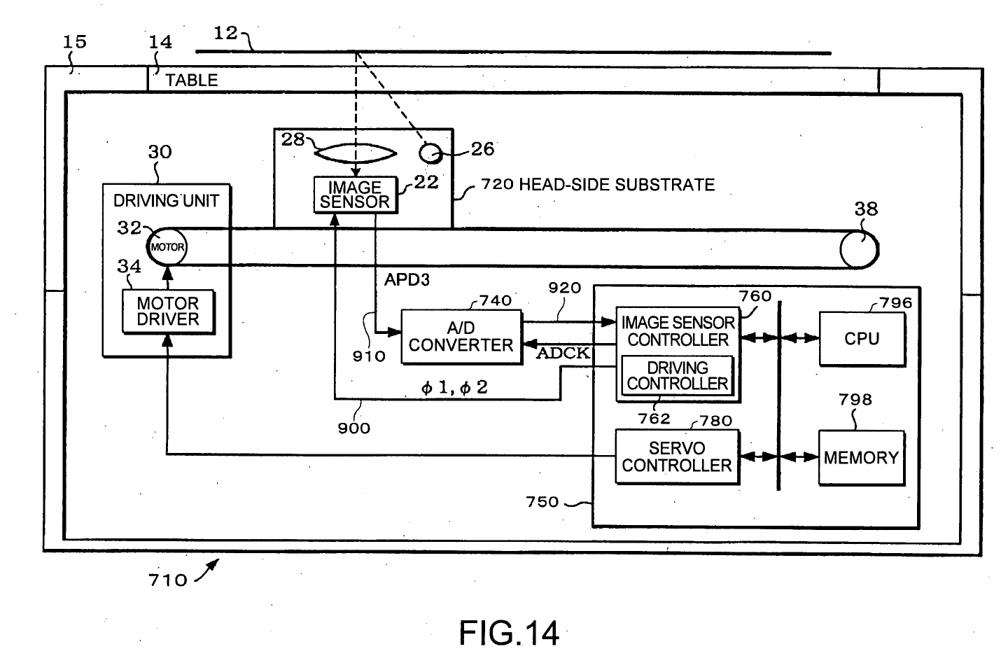

FIG. 14 shows an electronic apparatus 710 of a comparative example according to the present embodiment. The electronic apparatus 710 includes a head-side substrate 720. Mounted on this head-side substrate 720 is the image sensor 22 and an optical system (optical head) including the light source 26 and the lens 28. Analog image data APD3 read by the image sensor 22 are input into an A/D converter 740. The A/D converter 740 converts the data into digital image data (image signal) and outputs converted data to a main substrate 750.

The main substrate 750 includes an image sensor controller 760. The image sensor controller 760 controls the image sensor 22. The controller generates various types of controlling signals and driving patterns and outputs them to the image sensor 22. The image sensor controller 760 also receives digital image data from the A/D converter 740 and provides various types of image processing, including gamma conversion, shading processing and binarization processing. A driving controller 762 included in the image sensor controller 760 generates driving clocks Φ1 and Φ2 and outputs them to the image sensor 22.

In the electronic apparatus 710, radiation noise attributed to the driving clocks Φ1 and Φ2 is occurred at a signal channel 900. In addition, since the image data APD3 are output as a high-frequency clock, radiation noise also occurs at signal channels 910 and 920. Moreover, cables provided with the signal channels 900, 910 and 920, for example, have certain lengths so that the head-side substrate 720 can be moved within a predetermined range. This structure further enhances the influence of the radiation noise occurring at the signal channels 900, 910 and 920.

In order to reduce such radiation noise, a measure against EMI is required, for example, by shielding the cables with additional parts to the cables. This addition takes time in product design and increases production costs as a result.

In order to address this issue, the analog front-end circuit 24 according to the present embodiment or its modification, the analog front-end circuit 824, can supply the image data DPD as a clock that has been subject to the above-described spread spectrum modulation to the main substrate 50, for example. Consequently, peak values of the frequency spectrum can be spread, and thereby the radiation noise attributed to the output clocks can be reduced. In other words, the analog front-end circuits 24 and 824 can lower production costs compared with the comparative example.

In the analog front-end circuit 24 according to the present embodiment, the timing generator 300 generates, for example, the driving clocks Φ1 and Φ2 based on the reference clock CLK1 that has not been subject to spread spectrum modulation and supplies the clocks to the image sensor 22. Provided with the driving clocks Φ1 and Φ2 having fixed pulse widths, the image sensor 22 outputs more accurate image data than in a case where the driving clocks Φ1 and Φ2 are subject to spread spectrum modulation. Consequently, the electronic apparatus 10 including the analog front-end circuit 24 provides an effective measure against EMI and is capable of reading high-definition images.

With the electronic apparatus 710 of the comparative example, if the driving clocks Φ1 and Φ2 output from the image sensor controller 760 are subject to spread spectrum modulation for example, it is possible to spread peak values of the frequency spectrum of the driving clocks Φ1 and Φ2. However, since the driving clocks Φ1 and Φ2 are high-frequency clocks, this measure against EMI may be insufficient.

According to the present embodiment, since the driving clocks Φ1 and Φ2 are supplied to the image sensor 22 without using the coupling cable 800, the electronic apparatus 10 of the present embodiment can provide a better measure against EMI than the comparative example.

Furthermore, with the driving clocks Φ1 and Φ2 that have been subject to spread spectrum modulation in the comparative example, a range for spread spectrum modulation needs to be increased in order to provide a sufficient measure against EMI. However, the larger the modulation range is, the larger the variation of the pulse widths of the driving clocks Φ1 and Φ2 becomes. Accordingly, it is highly possible that image data output from the image sensor 22 will be an unexpected value, which may severely degrade image quality.

In the modification according to the present embodiment, the driving clocks Φ1 and Φ2 are generated on the side of the head-side substrate 20. The example therefore can provide a sufficient measure against EMI without increasing the range for spread spectrum modulation as mentioned above.

The driving clocks Φ1 and Φ2 can be supplied to the image sensor 22 without using the coupling cable 800 in the present embodiment and its modification, because the analog front-end circuits 24 and 824 include the timing generator 300.

As understood by those skilled in the art, various changes can be made with the present embodiment of the invention that has been described in detail without departing from the spirit and scope of the invention. All of such changes are to be regarded to be in the scope of the invention. For example, terms referred as broader or equivalent terms in the specification and drawings can be replaced with the broader or equivalent terms in any part of the specification and drawings.

The entire disclosure of Japanese Patent Application No. 2005-29231, filed February 4.

What is claimed is:

1. An analog front-end circuit that controls an imaging device and processes an analog image signal output from the imaging device, comprising:
an analog processor that receives an analog image signal from the imaging device, provides the image signal with predetermined processing, and outputs a resultant signal;
an A/D converter that performs A/D conversion with the image signal output from the analog processor;
a holding circuit that holds digital image data output from the A/D converter;
a timing generator that, based on a first reference clock, generates a plurality of clocks and outputs the clocks to at least one of the analog processor and the A/D converter; and
a spread spectrum modulation circuit that performs spread spectrum modulation with the first reference clock and outputs a resultant clock that has been subject to the spread spectrum modulation as a modulated clock to the holding circuit;
wherein the holding circuit holds the digital image data from the A/D converter based on the modulated clock output from the spread spectrum modulation circuit.

2. The analog front-end circuit according to claim 1,
wherein the timing generator generates, based on the first reference clock that has not been subject to spread spectrum modulation, a plurality of driving clocks that have not been subject to spread spectrum modulation for driving the imaging device and outputs the clocks to the imaging device, and
the signal of the image data output from the holding circuit is a
signal that has been subject to spread spectrum modulation.

3. The analog front-end circuit according to claim 1, further comprising:
a PLL circuit that generates the first reference clock;
wherein the PLL circuit receives a second reference clock, multiplies a frequency of the second reference clock with N that is a natural number more than 1, and outputs a resultant clock as the first reference clock.

4. The analog front-end circuit according to claim 1,
wherein the timing generator generates, based on the first reference clock that has not been subject to spread spectrum modulation, an A/D conversion clock that has a lower frequency than the first reference clock, and outputs the clock to the A/D converter.

5. The analog front-end circuit according to claim 1,
wherein the analog processor provides correlated double sampling and amplification as the predetermined processing.

6. The analog front-end circuit according to claim 1,
wherein the timing generator includes a clock pattern setting register that sets patterns of the plurality of clocks, and
the timing generator generates the plurality of clocks with different clock patterns from the first reference clock based on set values in the clock pattern setting register.

7. An electronic apparatus, comprising:
a head-side substrate on which the analog front-end circuit according to claim 1 and an imaging device are mounted;
a main substrate on which an image processor that processes image data output form the analog front-end circuit is mounted; and
a coupling cable that couples the head-side substrate and the main substrate;
wherein a signal of image data that have been subject to spread spectrum modulation is transferred via the coupling cable.

8. The electronic apparatus according to claim 7,
wherein the plurality of driving clocks for driving the imaging device is supplied from the analog front-end circuit to the imaging device without using the coupling cable.

9. An electronic apparatus, comprising:
a head-side substrate on which an analog front-end circuit that controls an imaging device and processes an analog image signal output from the imaging device is mounted;
a main substrate on which an image processor that processes image data output form the analog front-end circuit is mounted; and
a coupling cable that couples the head-side substrate and the main substrate;
the analog front-end circuit including:
an analog processor that receives an analog image signal from the imaging device, provides the image signal with predetermined processing, and outputs a resultant signal;
an A/D converter that performs A/D conversion with the image signal output from the analog processor;
a timing generator that, based on a modulated clock, generates a plurality of clocks and outputs the clocks to at least one of the analog processor and the A/D converter; and
a spread spectrum modulation circuit that performs spread spectrum modulation with a first reference clock and outputs a resultant clock that has been subject to the spread spectrum modulation as a modulated clock to the timing generator;
wherein a signal of image data that have been subject to spread spectrum modulation is transferred via the coupling cable.

10. The electronic apparatus according to claim 9,
wherein the analog front-end circuit includes a PLL circuit that generates the first reference clock, and
the PLL circuit receives a second reference clock, multiplies a frequency of the second reference clock with N that is a natural number more than 1, and outputs a resultant clock as the first reference clock.

11. The electronic apparatus according to claim 9,
wherein the timing generator generates an A/D conversion clock that has a lower frequency than the modulated clock based on the modulated clock, and outputs the clock to the A/D converter.

12. The electronic apparatus according to claim 9,
wherein the timing generator includes a clock pattern setting register that sets patterns of the plurality of clocks, and
the timing generator generates the plurality of clocks with different clock patterns from the modulated clock based on set values in the clock pattern setting register.
